(19) United States
(12) Patent Application Publication
(10) Pub. No.: US 2017/0291263 A1
(43) Pub. Date: Oct. 12, 2017

(54) ALLOY SELECTION METHOD FOR ADDITIVE MANUFACTURING

(71) Applicant: Delavan Inc, West Des Moines, IA (US)

(72) Inventors: Sergey Mironets, Charlotte, NC (US); William L. Wentland, Rockford, IL (US); Eric Karlen, Rockford, IL (US); Matthew Donovan, Ankeny, IA (US); Thomas J. Ocken, Des Moines, IA (US); Kiley J. Versluys, Hartford, CT (US); Robert Bianco, Strongsville, OH (US); Diana Giulietti, Tariffville, CT (US)

(21) Appl. No.: 15/095,574

(22) Filed: Apr. 11, 2016

(51) Int. Cl. B23K 31/12; B22F 3/24; B22F 9/04; C22C 1/02; B33Y 40/00; B23K 15/00; B23K 31/02; B22D 13/00; B22F 3/105; B33Y 10/00

(52) U.S. Cl. CPC B23K 31/125; B22F 3/1055; B22F 3/24; B22F 9/04; B33Y 10/00; B33Y 40/00; B23K 15/0086; B23K 31/02; B22D 13/00; C22C 1/02; B22F 2003/248; B22F 2998/10

(57) ABSTRACT

A method for selecting an alloy for additive manufacturing includes melting a first material and a second material together to create a material melt, spinning the material melt to create melt spun ribbons, welding the ribbons together to produce a weld, and determining a weld quality of the weld.

### BACKGROUND

1. Field

The present disclosure relates to additive manufacturing systems, more specifically to alloy selection for additive manufacturing.

2. Description of Related Art

There are many existing methods for rapid development and assessment of new materials in the compositional design space. The disadvantage of existing methods is that they do not address material weldability, which can be important for Laser Powder Bed fusion (LPBF) and Electron Beam Melting (EBM) Additive Manufacturing (AM). These methods require multiple iterations of producing powder lots and trying the powdered alloys for AM, which leads to higher development cost and longer lead time.

Such conventional methods and systems have generally been considered satisfactory for their intended purpose. However, there is still a need in the art for improved alloy selection for additive manufacturing. The present disclosure provides a solution for this need.

### SUMMARY

A method for selecting an alloy for additive manufacturing includes melting a first material and a second material together to create a material melt, spinning the material melt to create melt spun ribbons, welding the ribbons together to produce a weld, and determining a weld quality of the weld.

Melting the first material and the second material can include melting a first elemental metal and a second element metal together. Melting the first material and the second material can include melting a first alloy and a second alloy together.

Welding the melt spun ribbons can include welding the ribbons into a single layer. In certain embodiments, welding the ribbons can include welding the ribbons in a stacked arrangement.

Determining the quality of weld can include cutting the melt spun ribbons at the weld to inspect the weld quality. The method can further include creating a powder mixture of the first material and the second material if the weld quality is determined to be acceptable.

The method can further include additively manufacturing an article from the powder mixture. In certain embodiments, the method can include subjecting the article to post processing and/or quality testing. Post processing and/or quality testing can include at least one of heat treatment or stress relief tests, or any other suitable procedure. The method can further include attaching one or more of the ribbons to a build plate of an additive manufacturing system before welding the ribbons together.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a flow diagram of an embodiment of a method in accordance with this disclosure.

### DETAILED DESCRIPTION

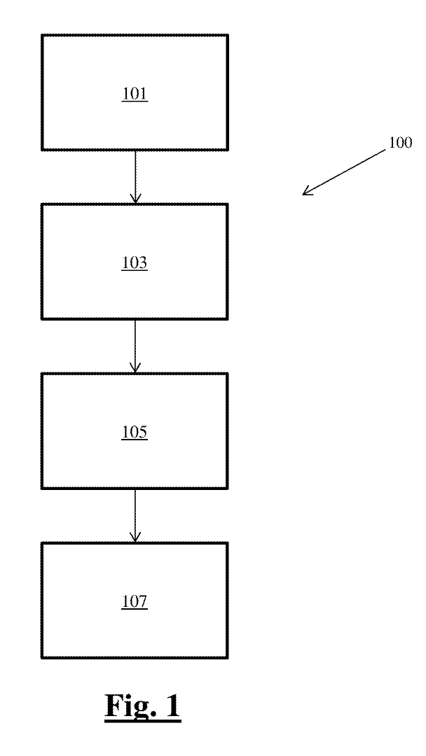

Reference will now be made to the drawings wherein like reference numerals identify similar structural features or aspects of the subject disclosure. For purposes of explanation and illustration, and not limitation, an illustrative view of an embodiment of a method in accordance with the disclosure is shown in FIG. 1 and is designated generally by reference character 100. The systems and methods described herein can be used to improve selection of alloys for additive manufacturing processes, for example.

Referring to FIG. 1, a method 100 for selecting an alloy for additive manufacturing (e.g., laser powder bed fusion, electron beam melting) includes melting (e.g., at block 101) a first material and a second material together to create a material melt. Melting the first material and the second material can include melting a first elemental metal and a second element metal together. Melting the first material and the second material can include melting a first alloy and a second alloy together. Any other suitable materials are contemplated herein for melting together (e.g., polymers, ceramics).

The method 100 also includes spinning (e.g., at block 103) the material melt to create melt spun ribbons. The melt spun ribbons can be any suitable size and/or shape. For example, the melt spun ribbons can be produced with a thicknesses similar to typical powder layers used in additive manufacturing processes (e.g., laser powder bed fusion or electron beam melting).

The method 100 further includes welding (e.g., at block 105) the melt spun ribbons together to produce a weld. Any additive manufacturing welding method (e.g., laser welding, electron beam melting) or any other suitable method for welding is contemplated herein. Welding the melt spun ribbons can include welding the ribbons into a single layer (e.g., side by side). In certain embodiments, welding the ribbons can include welding the ribbons in a stacked arrangement such that each ribbon forms a layer.

In certain embodiments, one or more melt spun ribbons can be attached (e.g., welded) directly to a build plate of an additive manufacturing system and then welded by the additive manufacturing system with other ribbons. In systems having a recoater, for example, the recoating system can be deactivated and the ribbons can be placed one on top of another to facilitate consolidation of multiple ribbons in a layered/stacked fashion.

The method 100 also includes determining (e.g., at block 107) a weld quality of the weld. Determining the quality of weld can include cutting the melt spun ribbons at the weld to inspect the weld quality.

The method 100 can further include creating a powder mixture of the first material and the second material if the weld quality is determined to be acceptable. The method 100 can further include additively manufacturing an article from the powder mixture. In certain embodiments, the method 100 can further include subjecting the article to post processing and/or quality testing. Post processing and/or quality testing can include at least one of heat treatment or stress relief tests, or any other suitable procedure (e.g., ultrasonic tests).

Utilizing embodiments as described above allow for powders suitable for additive manufacturing processes (e.g., laser melting), for example that have suitable solidification rates, to be determined. This can provide significant advantages over other additive manufacturing alloy development methods because multiple chemical composition ribbons can be evaluated for weldability. Also, certain embodiments that are attached to the build plate of existing systems can enable design of experiment with different processing parameters, which can substantially reduce the development of the laser powder bed fusion processing parameters, for example. Furthermore, consolidated specimens made of multiple layers of ribbons can be used for optimization of heat treating parameters and also for mechanical testing. Ribbons can be also used for developing solid state bonding additive manufacturing methods, like ultrasonic consolidation for example.

As described above, embodiments can reduce the cost and lead time for development of new alloys for additive manufacturing. Certain benefits include: producing desired chemical composition of precursor alloys utilizing adequate solidification rate; evaluation of material weldability before producing powders; speeding up of additive manufacturing processing parameter optimization; defining proper heat treatments or other post processing to meet the minimum properties requirement for a certain component design space; and obtaining mechanical properties of new material

The methods and systems of the present disclosure, as described above and shown in the drawings, provide for alloy selection methods with superior properties over traditional methods. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A method for selecting an alloy for additive manufacturing, comprising:
melting a first material and a second material together to create a material melt;
spinning the material melt to create melt spun ribbons;
welding the ribbons together to produce a weld; and
determining a weld quality of the weld.

2. The method of claim 1, wherein melting the first material and the second material includes melting a first elemental metal and a second element metal together.

3. The method of claim 1, wherein melting the first material and the second material includes melting a first alloy and a second alloy together.

4. The method of claim 1, wherein welding the melt spun ribbons includes welding the ribbons into a single layer.

5. The method of claim 1, wherein welding the ribbons includes welding the ribbons in a stacked arrangement.

6. The method of claim 1, wherein determining the quality of weld includes cutting the melt spun ribbons at the weld to inspect the weld quality.

7. The method of claim 1, further comprising creating a powder mixture of the first material and the second material if the weld quality is determined to be acceptable.

8. The method of claim 7, further comprising additively manufacturing an article from the powder mixture.

9. The method of claim 8, further comprising subjecting the article to post processing and/or quality testing.

10. The method of claim 9, wherein the post processing and/or quality testing includes at least one of heat treatment or stress relief tests.

11. The method of claim 1, further including attaching one or more of the ribbons to a build plate of an additive manufacturing system before welding the ribbons together.
